(19) United States
(12) Patent Application Publication
(10) Pub. No.: US 2008/0288328 A1
(43) Pub. Date: Nov. 20, 2008

(54) CONTENT ADVERTISING PERFORMANCE OPTIMIZATION SYSTEM AND METHOD

(76) Inventors: Bryan Michael Minor, Mount Vernon, WA (US); Douglas B. Clarkson, Renton, WA (US); William T. G. Johnson, Bellevue, WA (US); Michel F. Pettigrew, Edgewood, WA (US); Corey L. Samuels, Seattle, WA (US); Tamas Frajka, Seattle, WA (US)

Correspondence Address: AXIOS LAW GROUP. PLLC, 1525 FOURTH AVENUE, SUITE 800, SEATTLE, WA, 98101, US

(21) Appl. No.: 11/961,485

(22) Filed: Dec. 20, 2007

Related U.S. Application Data
(60) Provisional application No. 60/938,455, filed on May 17, 2007.

(51) Int. Cl. G06Q 30/00; G06F 17/00

(52) U.S. Cl. 705/10

(57) ABSTRACT

A content targeted advertising performance optimization system and method are provided herein.

### RELATED REFERENCES

This application is a nonprovisional application of U.S. Provisional Application No. 60/938,455, filed May 17, 2007. The contents of that provisional application are incorporated herein by reference in their entirety.

### FIELD

The present invention relates to Internet advertising, and more particularly to a process for optimizing the performance of content targeted advertising.

### BACKGROUND

The Internet is a worldwide, publicly accessible network of interconnected computer networks that transmit data by packet switching using the standard Internet Protocol (IP). This “network of networks” comprises millions of smaller domestic, academic, business, and government networks, which together enable various services, such as electronic mail, online chat, file transfer, and the interlinked Web pages, Web sites, and other documents of the World Wide Web.

On many Web sites today, money is being made on Internet advertising. Product and service providers are often willing to pay to put their advertisements on sites where their advertisements may be exposed to potential clients, exposure that may result in clicks through to their sites and possible conversion into desired actions (e.g., sales, referrals, etc.).

Internet advertising is a large and growing business, currently dominated by Google Inc. of Mountain View Calif. (hereinafter “Google”). Google's Advertising Revenues in 2006 were in excess of $10B and grew nearly 60% year over year. Google AdWords and Google AdSense are responsible for a large portion of its advertising revenue. The Interactive Advertising Bureau recently highlighted the upward trend in online advertising when it announced a quarterly expenditure of $4B for the 3rd quarter of 2006. Other sites broke down that revenue to reveal that $2.7B came from Google AdWords/AdSense.

Many companies find internet advertising to be as effective as and often less costly than traditional media advertising. Print advertising in magazines, newspapers and trade magazines may be expensive and may have little impact. In addition, it may be difficult to measure the effectiveness of traditional advertising. By contrast, there may be a number of ways to measure the effectiveness of Internet advertising. Specific markets that may be difficult to isolate using traditional advertising methods may be relatively easy to target using Internet advertising.

Broadly speaking, there are at least two types of Internet advertising, “search-based” and “content targeted” advertising. Search-based advertising campaigns are generally based around “keywords.” An advertiser may create a list of keywords and agree to pay a certain amount when a search engine user searches for one of the keywords in the advertiser's list. In exchange for that payment, the search engine displays to the user an advertisement “sponsored” by the advertiser.

Some advertising services may provide feedback to advertisers concerning the efficacy of the advertiser's search-based keywords. In addition, search engine and content sites may assist advertisers in selecting keywords to purchase; they may provide information on the effectiveness of each individual keyword that a client uses, relating each keyword to impressions or clickthroughs.

While search-based advertising may be fairly well understood and easily managed by advertisers, it may be that more potential customers are directed to a landing page by content targeted advertising. (A landing page may be a page on an advertiser's Web site, but a landing page may also lead to any other location, such as a media company's landing page where visitor information is collected for later delivery to the advertiser.) Broadly defined, content targeted advertising is advertising displayed on Web sites other than search engines or search-results pages. In other words, content targeted advertising is advertising displayed on Web sites that potential customers may see while making general use of the Internet (while “surfing”). According to one source, 95% of user time is spent viewing content pages, and 5% of time on search pages. Despite this huge disparity, advertisers tend to have fewer tools available to help them understand and manage content targeted advertising campaigns.

Like search-based advertising, content targeted advertising is based around keywords. Like a search-based advertiser, a content targeted advertiser typically “purchases” or bids-on one or more groups of keywords that are used to trigger the display of advertisements sponsored by the advertiser. However, despite these outward similarities, strategies for constructing an optimal search-based advertising campaign may differ significantly from strategies for constructing an optimal content targeted advertising campaign. For example, a keyword group that performs well in a search-based advertising campaign may not be nearly as effective when used for content targeted advertising.

The reason that the same group of keywords may perform differently in these two contexts has to do with the differences between the “ad selection algorithms” used by advertising network providers. While advertising network providers do not typically disclose the details of their ad selection algorithms, it may generally be the case that ad selection algorithms are designed in part to match a particular user with a particular sponsored advertisement that will be pertinent to the user's current interests. In the case of search-based advertising, the user's current interests may be represented by the string the user enters into a search engine. Because search engine users generally tend to use relatively short phrases as search strings, a search ad selection algorithm may have only a few words to use to determine which sponsored advertisement is the most pertinent. It is a common and relatively successful search-based advertising strategy to compile relatively large lists of possibly unrelated keywords, even hundreds of keywords, so as to match as many users' search terms as possible. Accordingly, many Internet advertisers have developed sets of hundreds or even thousands of keywords that are potentially pertinent to search engine users whom the advertisers wish to target.

However, simply using large sets of keywords can work against a content targeted advertiser. The mechanics of proprietary content ad selection algorithms may be relatively complex compared to search ad selection algorithms in part because content ad selection algorithms may use all or a large part of the content on a given Web page to select a particular sponsored advertisement that will be pertinent to the user's current interests. It can therefore be difficult to select an optimal group of keywords for a given ad campaign. It may even be that having large groups of unrelated keywords could reduce the frequency with which an ad is displayed on content sites. And even if a content targeted advertiser uses a smaller group of keywords, in some circumstances, adding or removing one or more keywords to or from an existing group may actually decrease the frequency of the ad being displayed.

All in all, it can be a difficult task to select an optimal subset from among seemingly countless possible groupings of hundreds of potentially relevant keywords. Given this complexity, it is perhaps not surprising that content targeted advertisers do not currently have a good way to optimize groupings of keywords from among the total set of potentially relevant keywords.

### BRIEF DESCRIPTION OF THE DRAWINGS

FIG. 1 is a system diagram of a number of devices in a network in accordance with one embodiment.

FIG. 2 is a system diagram of a content page and an advertising campaign in an ad network server in accordance with one embodiment.

FIG. 3 is a diagram of components of a content keyword optimization server in accordance with one embodiment.

FIG. 4 is a data flow diagram illustrating the ad selection process in accordance with one embodiment.

FIG. 5 is a diagram of an optimization “funnel” in accordance with one embodiment.

FIG. 6 is a data flow diagram illustrating the keyword group optimization process in accordance with one embodiment.

FIG. 7 is flow diagram of actions for optimizing keyword groups in accordance with one embodiment.

FIGS. 8 and 9 are flow diagrams of neural network based Iterative Refinement Processes in accordance with one embodiment.

FIGS. 10 and 11 are flow diagrams of genetic based Iterative Refinement Processes in accordance with one embodiment.

FIGS. 12 and 13 are flow diagrams of adaptive logistic based Iterative Refinement Processes in accordance with one embodiment.

### DESCRIPTION

The detailed description that follows is represented largely in terms of processes and symbolic representations of operations by conventional computer components, including a processor, memory storage devices for the processor, connected display devices, and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

Advertisers may have difficulty ascertaining a priori whether their content targeted advertising will be more effective by having a large or small number of keywords or by picking a specific set of keywords. To gather data on content keywords with tools available today, an advertiser may have to run a separate content campaign for each keyword. But such a campaign may not reveal the effectiveness of grouping a list of keywords together. Running a separate campaign for each keyword and each subset of keywords may also be unduly burdensome: even a modest campaign of 200 key words may require a great number of separate subsets, specifically 2̂200-1 (about 10̂70) subsets, to search completely.

Those of ordinary skill in the art will appreciate that a content advertising environment may include many more components than those illustrated, and illustrated components may be more complex than those described in this application. However, it is not necessary that all components be shown and exhaustively described in order to disclose an illustrative embodiment.

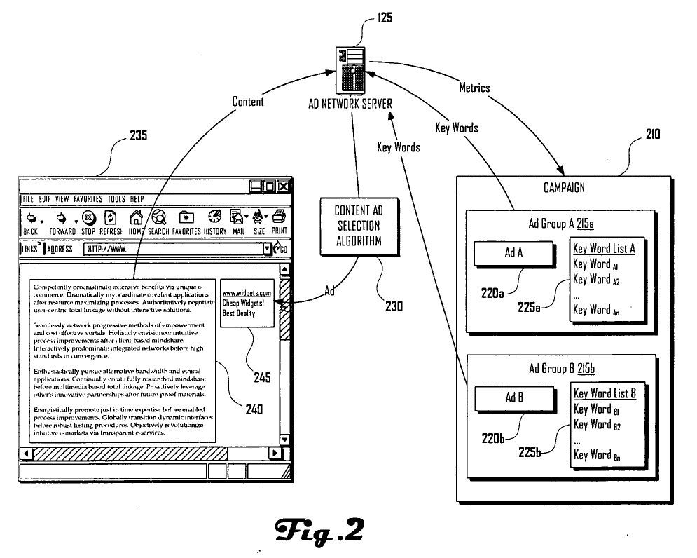

The content keyword optimization processes described herein may be particularly suited to optimizing content targeted advertising such as the Google AdWords program and similar services from other ad network providers. Such content targeted advertising systems may have one or more of the following attributes as illustrated in FIG. 2:
An ad campaign 210 may be focused on just content based marketing.
An advertiser may submit one or more groups of keywords 225 for each ad group 215 within a content targeted ad campaign 210.
For each ad group 215, the keyword list 225 may be evaluated in the aggregate by the Ad network content ad selection algorithm 230.
Overlapping keyword sets 225 may cause ad groups 215 to compete for advertising opportunities in unanticipated ways.

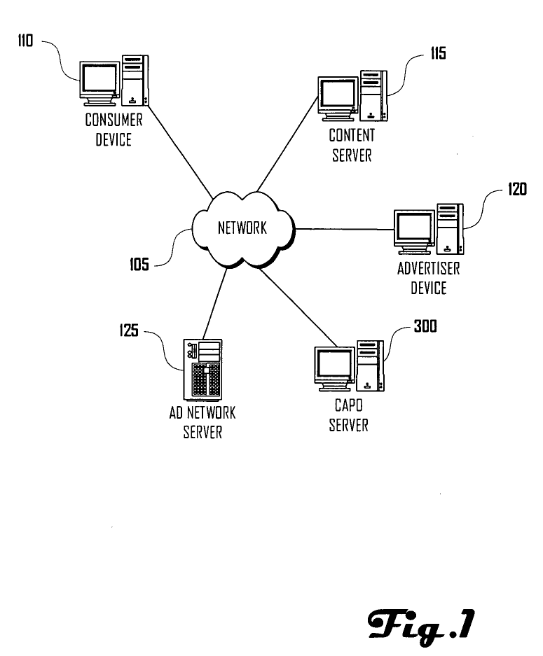

FIG. 1 illustrates a typical scenario wherein various devices and servers 110-125, 300 variously communicate via a network 105. In many embodiments, the network 105 may be the Internet. In exemplary embodiments a consumer device 110 may be a personal computer, a game console, a set-top box, a handheld computer, a cell phone, or any other device that can access information on the network 105. As used herein, the term “consumer” refers to any entity that may be in a position to purchase or recommend products or services that are the subject of content targeted advertising, whether such purchase or recommendation is for personal, business, group, or other use.

A content server 115 may be any device that provides content to a consumer device 110 across a network 105. In an exemplary embodiment, a content server 115 may host and serve Web pages. A content server 115 is generally operated by a content provider, which may or may not be associated with any particular advertiser or consumer.

The advertiser device 120 represents a device or devices that are operated by or on behalf of an advertiser. Advertiser devices 120 may be used for managing the advertiser's ad campaigns 210 and/or for providing, promoting, and/or selling the goods and/or services that are the subject of the ad campaign 210. For example, the advertiser device 120 may include a personal computer used by an advertising executive or marketing employee to manage the advertiser's content ad campaigns, but the advertiser device 120 may also include Web servers and/or e-commerce servers operated by or on the behalf of the advertiser.

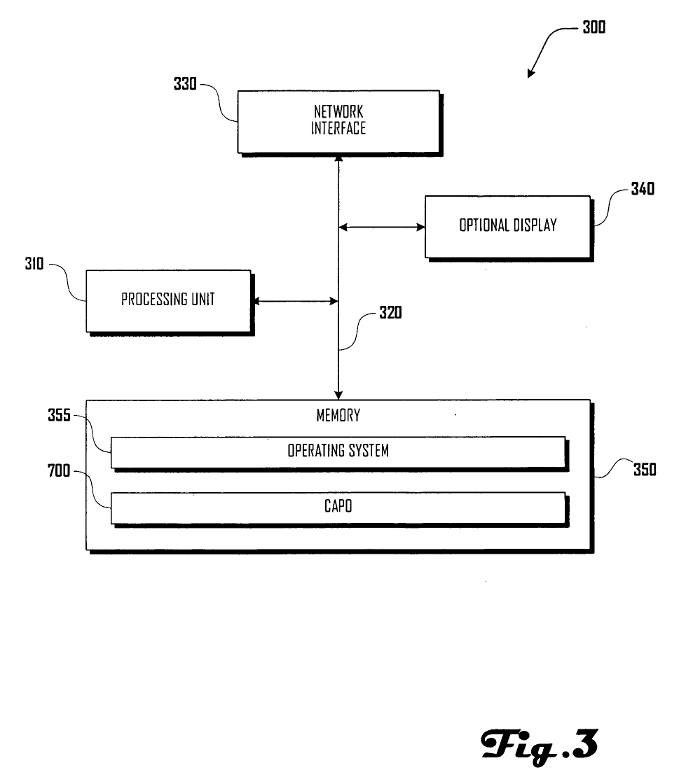

The ad network server 125 represents a server or servers that are operated by or on behalf of a content ad network provider, such as Google, Yahoo! Inc. of Sunnyvale Calif., Microsoft Corporation of Redmond Wash., and the like. The Content Advertising Performance Optimization (“CAPO”) server 300 is described in FIG. 3.

Although only one instance of each type of device and server are illustrated, in some embodiments, many such devices and servers may be present.

FIG. 2 shows a broad overview of an exemplary content advertising environment. At the center is an ad network server 125. An advertiser creates a content targeted advertising campaign 210, which may include one or more ad groups 215a-b. The advertiser may create a specific content targeted advertising campaign 210 to accommodate a product launch, a marketing campaign, a holiday, known fluctuations in a sales cycle (e.g. at the beginning or the end of a month), or for other reasons. In turn, an ad group 215 includes a list of keywords 225a-b and an ad 220a-b. A keyword list 225 may include as few as one keyword or as many as hundreds or even thousands of keywords. An ad 220 may be a simple text ad including a link to a “landing page” that the advertiser wishes consumers to visit, or an ad 220 may include an image, animation, video, interactive object, or virtually any other type of media that can be displayed on a Web page. The ad network may include thousands of ad groups 215, each with an associated keyword list 225.

A content provider may agree to display on a Web page 235 an ad 245 provided by an ad network server 125. Typically, an ad network provider attempts to serve ads 145 that will be of interest to consumers visiting a particular Web page 235. To determine which potential ads 220 are likely to be of interest, an ad network server 125 may use a content ad selection algorithm 230 to compare the content 140 of the Web page 235 with the keyword lists 225 of some or all of the ad groups 215 maintained by advertisers.

As noted above, FIG. 3 illustrates an exemplary CAPO server 300. In some embodiments, the CAPO server 300 may include many more components than those shown in FIG. 3. However, it is not necessary that all of these generally conventional components be shown in order to disclose an illustrative embodiment. As shown in FIG. 3, the CAPO server 300 includes a network interface 330 for connecting to the network 105. Those of ordinary skill in the art will appreciate that the network interface 330 includes the necessary circuitry for such a connection and is constructed for use with the appropriate protocol.

The CAPO server 300 also includes a processing unit 310, a memory 350 and may include an optional display 340, all interconnected along with the network interface 330 via a bus 320. The memory 350 generally comprises a random access memory (“RAM”), a read only memory (“ROM”), and a permanent mass storage device, such as a disk drive. The memory 350 stores program code for a CAPO 700, as described herein.

In addition, the memory 350 also stores an operating system 355. It will be appreciated that these software components may be loaded from a computer readable medium into memory 350 of the CAPO server 300 using a drive mechanism (not shown) associated with a computer readable medium, such as a floppy disc, tape, DVD/CD-ROM drive, memory card, via the network interface 330 or the like.

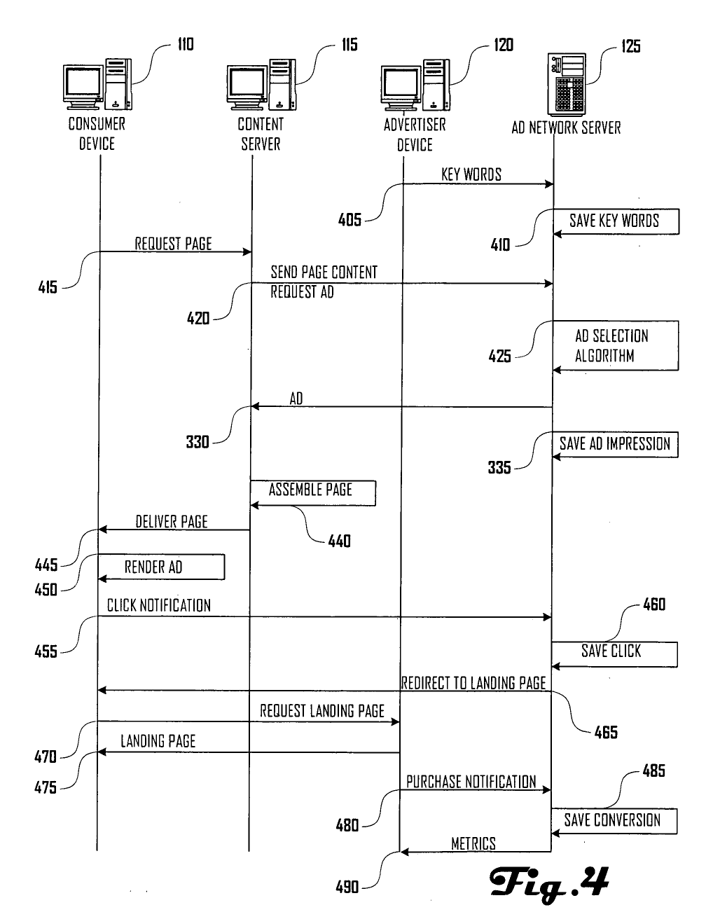

FIG. 4 provides an exemplary overview of the data flow and interactions involved in delivering content targeted ads to consumers. Initially, an advertiser creates a marketing campaign having an ad group 215 and uses an advertiser device 120 to send 405 a set of keywords 225 to the ad network server 125, which stores the list 410. A consumer device 110 sends a page request 415 to a content server 115, operated by a content provider. If the content provider has agreed to display ads on the requested Web page 235, the content server 115 sends an ad request 420 to the ad network server 125. The ad request may also be accompanied by some or all of the content 140 on the requested page. The ad network server 125 runs 425 its content ad selection algorithm 230, selects an appropriate ad 245 to be displayed on the requested Web page 235, sends the ad 430 to the content server 115, and records 435 an “impression” for the selected ad 245. (An impression is one instance of an ad being displayed on a consumer device 110.) The content server 115 assembles the page 440, incorporating the ad 245, and delivers it 445 to the consumer device 110, which renders 450 the requested page 235 (including the ad 245). If a consumer clicks on the rendered ad, the consumer device 110 detects the click and sends a click notification 455 to the ad network server 125. The ad network server 125 records 460 a “click” for the clicked ad, looks up the address of the landing page for the clicked ad, and sends a redirect 465 to the consumer device 110. The consumer device 110 then sends a request 470 for the indicated landing page to an advertiser device 120. After the consumer device 110 receives the landing page 475, the advertiser device 120 may detect that the consumer has purchased the advertised product or service. In such a case, the advertiser device 120 notifies 480 the ad network server 125 that there has been a “conversion.” Periodically, the ad network server 125 may send metrics 490 to an advertiser device 120, metrics that may include information related to the impressions, clicks, and conversions data that were recorded by the ad network server 125. Those of ordinary skill in the art will appreciate that many advertisers derive income mainly from conversions and that for such advertisers, impressions and clicks are valuable mainly to the extent that they lead to conversions. Such advertisers may therefore wish to optimize their ad groups 215 to maximize the number of conversions that they generate.

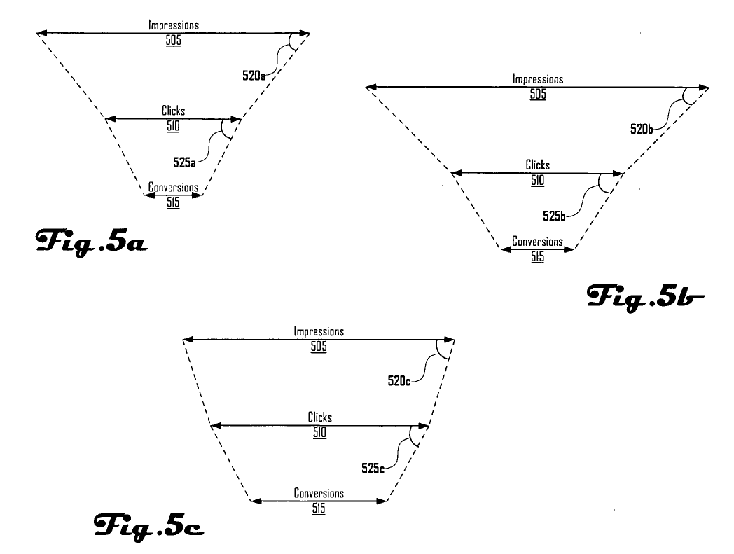

As illustrated in FIGS. 5a-c, the performance metrics of an ad group 215 may be visualized as a “funnel” insofar as a large number of impressions 505 may lead to a smaller number of clicks 510, which may in turn lead to a still smaller number of conversions 515. In this visualization, the ratios of clicks 510 to impressions 505 are represented by the angles 520, and the ratios of conversions 515 to clicks 510 are represented by the angles 525. FIG. 5a illustrates an un-optimized ad group 215. FIG. 5b illustrates an ad group 215 that has been optimized to increase the number of impressions 505, but the ratios of conversions 515 to clicks 510 to impressions 505 are the same as those in FIG. 5a. Accordingly, FIG. 5b is geometrically similar to FIG. 5a (angle 520b is the same as 520a and angle 525b is the same as 525a). FIG. 5c illustrates an ad group that has been not been optimized to increase the number of impressions 505, but has been optimized to increase the ratios of clicks 510 per impression and conversions 515 per click 510. Accordingly, angles 520c and 525c are greater than angles 520a and 525c.

Thus, FIGS. 5b-c illustrate two approaches to ad group 215 optimization: conversions 515 can be increased by making the “funnel” wider, as illustrated in FIG. 5b, and by making the “walls” of the “funnel” more parallel by increasing the angles 520 and 525, as illustrated in FIG. 5c. In addition, these two approaches may be combined.

However, while the goals of ad group 215 may be relatively straightforward, the actual mechanics of optimizing an ad group 215 may be complex and unpredictable for several reasons. The first reason is the sheer size of the search space. An advertiser may be able to influence the number of impressions an ad group generates by altering the ad group's keyword list 225. However, an advertiser may have a total set of several hundred or more keywords, which may be combined in almost countless ways. For example, for an ad group of 100 keywords, there are (2̂100-1)=1.27*10̂30 ways to uniquely combine the keywords.

The second reason is the unknown and changing nature of the algorithm that ad network server 125 operators use to select ads for display. Ad network operators such as Google and Yahoo often purposefully keep secret their content ad selection algorithms 230 and may alter their content ad selection algorithms 230 from time to time. As a result, it may be difficult or impossible to predict how a given group of keywords may perform, and the performance of a given set of may vary over time as the ad network operator changes its selection algorithm. In addition, keyword sets that do not obviously overlap may ultimately compete with each other for advertising opportunities in unpredicted ways.

Given the difficulty of making accurate predictions about the efficacy of a group of keywords, to evaluate a prospective keyword list 225, it may be necessary to actually create an ad group 225 using the prospective list and evaluate performance metrics collected by the ad network server 125. However, as noted above, many advertisers have hundreds or thousands of keywords. For such advertisers, it may impractical to determine more effective keyword subsets by manually testing and evaluating all possible keyword permutations.

Although creating an optimal keyword list 225 for an ad group 215 presents a difficult problem, various embodiments described herein use a CAPO to iteratively test and compare the effectiveness of various groupings of keywords. A CAPO is a process for automating the process of optimizing a group of keywords for content ad placement without requiring that the advertiser know anything about the underlying ad selection algorithm. In an exemplary embodiment, the CAPO process may be able to adapt to any particular ad selection algorithm used by an ad network server 125. Using such a CAPO, an advertiser may with minimal manual effort achieve systematic improvement in the performance of its advertising campaign. An advertiser may interact with a CAPO as a web service that can be accessed remotely by the advertiser, or as a consulting type service performed by CAPO-provider personnel on behalf of the client.

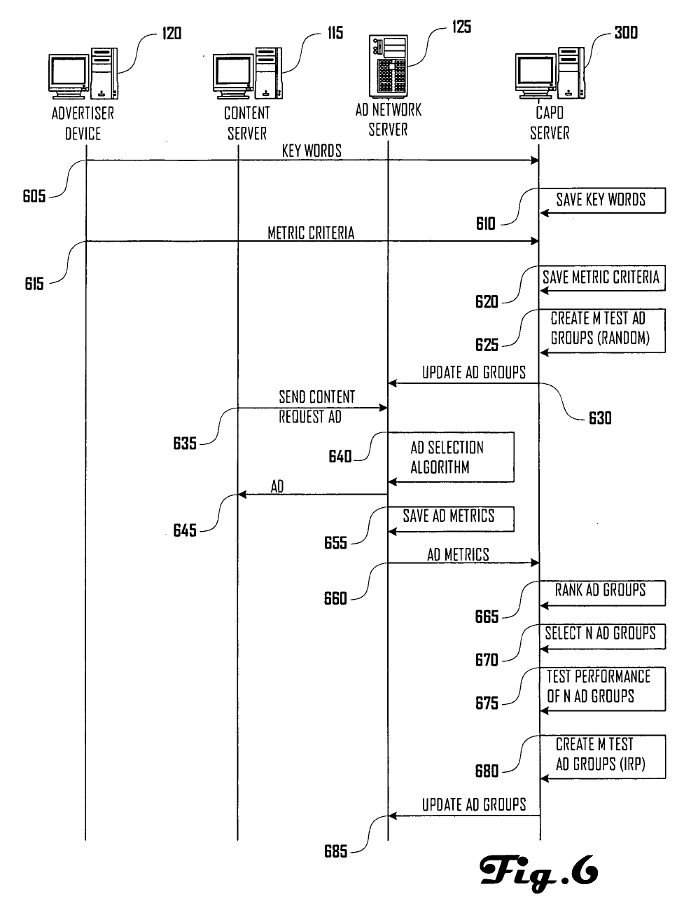

FIG. 6 illustrates a data flow associated with an exemplary CAPO environment. To begin the process, an advertiser device 120 transmits its complete set of keywords 605 to a CAPO server 300, which stores the keywords 610. The advertiser device 120 also transmits a set of metric criteria 615 (including metrics of interest and target criteria) to the CAPO server 300, which stores the metrics criteria 620. The metrics of interest define measurable data that the advertiser is interested in optimizing (e.g., impressions, clicks, conversions, cost per conversion, and the like). The CAPO server 300 then creates a control ad group, consisting of all keywords, and M test ad groups consisting of randomly selected subsets of keywords 625. The CAPO server 300 then updates the ad groups 630 on the ad network server 125 to include the control ad group and the M test ad groups. These M+1 ad groups are run for a period of time within an ad campaign (content servers 115 request ads 635 and the ad network server selects ads 640 and delivers the selected ads 645 to the content server 115 to be transmitted and displayed to a consumer). During this ad campaign, the ad network server 125 collects performance metrics for the M+1 ad groups 655 and then transmits those metrics 660 to the CAPO server 300.

The CAPO server 300 rank orders the M test groups 665 according to the metrics of interest and selects N of the better-performing complementary (non-competing) test groups 670. The CAPO server 300 evaluates the performance of the N better-performing test groups 675, if the N better-performing test groups meet the target criteria, the optimization process ends and the advertiser may either run its campaign using the N better-performing test groups or it may begin a new round of optimization using different metric criteria. If, on the other hand, the N better-performing test groups do not meet the target criteria, then the CAPO server 300 uses an Iterative Refinement Process 680 to create a new set of M test groups based on the N better-performing test groups. The CAPO server 300 then updates the ad groups 685 on the ad network server 125 to include the newly created M test groups. The new M test groups and the control group are run for a period of time within an ad campaign, their performance is evaluated, N better performing groups are selected, M new test groups are created, and the process repeats until the target criteria are met. By changing the groups of keywords in the test groups over multiple iterations, more optimal groupings of keywords may be generated, groupings that may generate more impressions, more clickthroughs, more conversions, cheaper conversions, and the like.

FIG. 7 is a flow diagram illustrating of a CAPO process. An advertiser has a large set of keywords and wishes to create an ad campaign 210 having an optimal set of ad groups 215. In block 705, the CAPO receives a set of T keywords from an advertiser device 120. This set may include hundreds or even thousands of keywords. In block 710, the CAPO receives from the advertiser device 120 a set of metric criteria. For example, an advertiser may be interested in increasing the number of impressions generated by ads 220 within a campaign 210. Or an advertiser may already have optimized for impressions 905 and may now wish to increase the number of clicks or conversions generated by ads 220 within a campaign 210. In addition to identifying metrics of interest, the metric criteria may also include a target or targets that will tell the CAPO when to stop iteratively optimizing the ad campaign 210.

In block 715, the CAPO creates a control ad group within the ad campaign 210. The control ad group includes the complete set of T keywords that the CAPO received in block 705. In decision block 720, the CAPO determines whether there exists a set of N better performing ad groups. On the first iteration, there is no set of N better performing ad groups, so the CAPO proceeds to subroutine 800, 1000, 1200 and creates within the ad campaign 210 a set of M test groups (M<T), each containing a randomly selected subset of keywords. In block 735, the M test groups and the control group are run for a period of time in an ad campaign 210. The period of time should allow enough metrics to be collected that the performance of the M test groups can be evaluated. In block 740, the ad campaign is stopped and the CAPO collects performance metrics for the M test groups. In block 745, the CAPO rank orders the M test groups based on the metrics of interest, and in block 750, the CAPO selects the N better performing test groups (1≦N≦M).

In decision block 755, the CAPO determines whether the performance of the selected N better performing test groups meets the target or targets the CAPO received in block 710. The target criteria may include performance metrics such as numbers of impressions, impression rate, clicks, click rate, conversions, or conversion rate, but the target criteria may also include CAPO test metrics, such as a number of iterations. For example, target criteria may cause the CAPO to terminate when the N better performing test groups reach 200 clicks per day or after 25 iterations of the CAPO process, whichever condition is met first. Alternately, the CAPO may terminate only after the N better performing test groups reach 200 clicks per day and the CAPO has performed at least 25 iterations. Those of ordinary skill in the art will appreciate that many combinations of various metric and target criteria are possible. If the target criterion is met, the CAPO proceeds to block 760, using the N better performing test groups as the production ad campaign.

If the N better performing test groups do not meet the target, however, the CAPO returns to decision block 720 and determines that there exists N better performing test groups. The CAPO therefore proceeds to subroutine 900, 1100, 1300, where an Iterative Refinement Process manipulates the keyword groups within the N better performing test groups to create a new set of M test groups within the test ad campaign. The CAPO then proceeds to blocks 735-755 using the new set of M test groups, and the iterative process continues until a terminal condition is found in decision block 755.

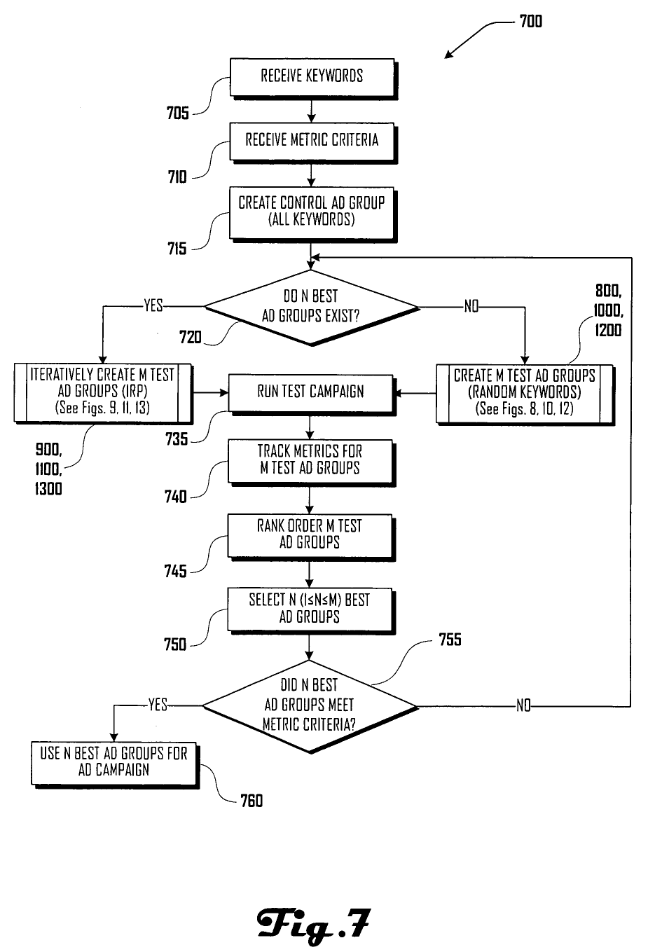

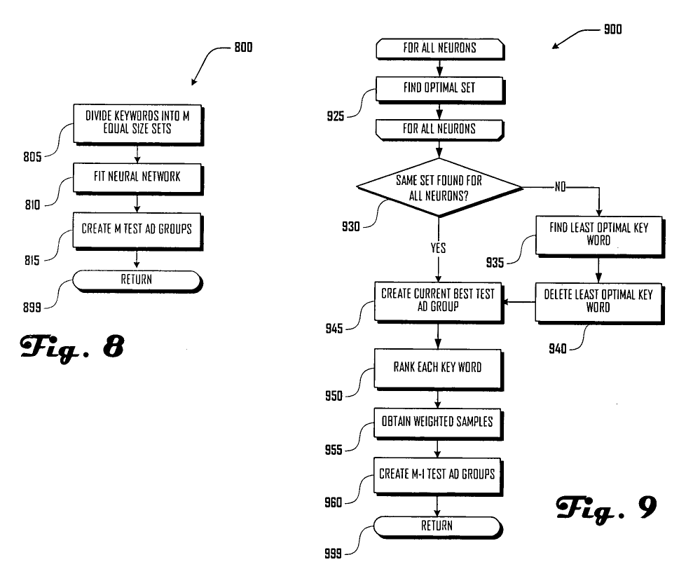

Several approaches can be taken to implementing the Iterative Refinement Process, which runs in subroutine 900, 1100, 1300, and the initial random test ad group creation subroutine 800, 1000, 1200. In one embodiment, illustrated in FIGS. 8 and 9, an artificial neural network or multi-layer perceptron can be trained to recognize the keywords in an ad group that contribute the most to the fitness function. Artificial neural networks are well known in the art and need not be described in detail to enable one skilled in the art to practice the claimed inventions. In such an embodiment, the Iterative Refinement Process may be implemented as a feed forward neural network in which the replications are the M test groups in each iteration, the outcome is the fitness function derived from the metric criteria, and there is one hidden layer.

Mathematically, such a network can be represented as:

$${\hat{y}}_{j} = {\sum }_{i = 1}^{n} {w}_{i} ρ ( {\sum }_{k = 1}^{p} {a}_{i , k} {x}_{j , k} + {β}_{i , k} ) + b ,$$

where n is the number of neurons in the network, p is the total number of T ad words to be considered, wᵢ, a_{i,k}, β_{i,k}, and b are parameters to be estimated, and p(z), the activation function, is defined as

$$p ( z ) = \frac{1}{1 + {e}^{- z}} .$$

Within this mathematical representation, j indexes the ad group, yⱼ is the observed ad group fitness function, and x_{j,k} is one if keyword k is in the ad group j, and is zero otherwise. In one embodiment, there are n=10 neurons, and the number of neurons may increase as the total number of keywords exceeds 200. The artificial neural network defines an over-parameterized non-linear optimization problem. Standard iterative methods (e.g., a back propagation algorithm) are used to train the neural network.

FIGS. 8 and 9 illustrate embodiments of subroutines 800 and 900 using an artificial neural network as the Iterative Refinement Process. FIG. 8 illustrates one such embodiment of subroutine 800. In block 805, the total set of keywords is divided into nearly equal sized sets of keywords such that each keyword appears in a fixed number of sets (no keyword may be eliminated altogether). In block 810, an initial fit to a neural network is determined. In block 815, M test ad groups are created using the nearly equal sized sets created in block 805. Processing returns to the main routine in block 899.

FIG. 9 illustrates an embodiment of subroutine 900 (the Iterative Refinement Process), wherein the initial fit to the neural network that was determined in block 810 is used to guide the selection of keywords for the next set of M test groups. A neural network can be represented as

$${\hat{y}}_{j} = {\sum }_{i = 1}^{n} {w}_{i} ρ ( {\sum }_{k = 1}^{p} {a}_{i , k} {x}_{j , k} + {β}_{i , k} ) + b$$

where n is the number of neurons in the network, p is the total number of keywords, wᵢ, a_{i,k}, β_{i,k} and b are parameters to be estimated, and

$$ρ ( z ) = \frac{1}{1 + {e}^{- z}}$$

is the activation function. During subroutine 900, keywords may be dropped from the test groups. Given a solution for the coefficients in the artificial neural network, one goal of the Iterative Refinement Process is to estimate optimal test groups by maximizing the fitness function with respect to the x_{j,k}. In some embodiments, a brute force approach (in which every combination of keywords is considered) can be used. However, if there are more than approximately 20 keywords, the brute force approach quickly becomes unfeasible. FIG. 9 illustrates an approach that may be more appropriate for large numbers of keywords. In block 925, for each neuron, the process finds a set of x_{j,k}==1 that maximizes the neuron function

$${\sum }_{k = 1}^{p} {a}_{i , k} {x}_{j , k} + {β}_{i , k}$$

when all wᵢ are positive. (For negative wᵢ, block 925 finds the keywords to minimize the function

$${\sum }_{k = 1}^{p} {a}_{i , k} {x}_{j , k} + {β}_{i , k} . )$$

Decision block 930 determines whether the same set of keywords is found for all neurons. If so, the current best group of keywords has been located, and processing proceeds to block 945, which creates an ad group based on the current best group of keywords. If decision block 930 determines that the same set of keywords is not found for all neurons, processing proceeds to block 935, which determines in a stepwise manner the keyword whose deletion would most increase the fitness function (where in one embodiment the neural network minimizes the fitness function). In block 940, at each step, the so determined least optimal keyword is deleted. The final group of keywords that is (approximately) best according to the current neural network is selected using, in one embodiment, a penalized fitness function. Processing then proceeds to block 945, which creates an ad group based on the approximately best group of keywords.

In blocks 950-60, the subroutine finds the remaining M−1 keyword groups needed to create the remaining M−1 test ad groups. Block 950 ranks each keyword according to its contribution (by itself) to the fitness function, obtaining in block 955 roughly equally sized samples from the keywords where the sampling is weighted such that the keyword contributing the most has the highest probability of selection. In block 960, M−1 test ad groups are created in accordance with the roughly equally sized samples obtained in block 955. In block 999, processing returns to the calling routine.

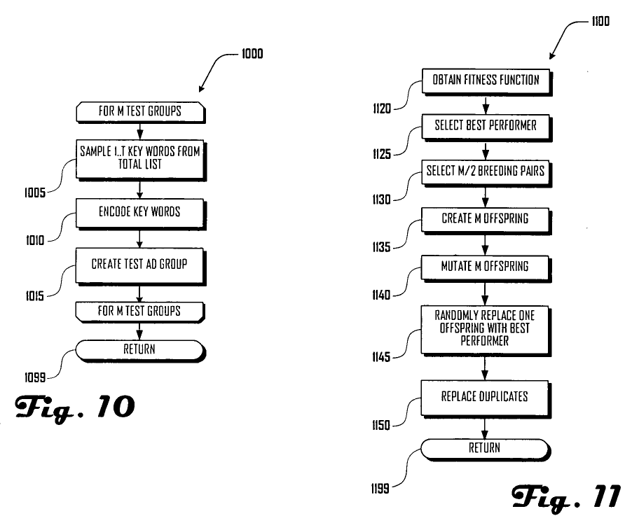

FIGS. 10 and 11 illustrate embodiments of subroutines 1000 and 1100 using a genetic algorithm as the Iterative Refinement Process. In one embodiment, a genetic algorithm may be used to refine and optimize the groups of keywords for test ad groups. Genetic algorithms are well known in the art and need not be described in detail to enable one skilled in the art to practice the claimed inventions.

FIG. 10 illustrates an embodiment of subroutine 1000. Given the total keyword set of size T, in block 1005, a group made up of from 1 to T keywords is randomly sampled from the total keyword set. In block 1010, the presence or absence of each keyword in the randomly sampled group is encoded as a bit string, and in block 1015, a test ad group is created using the randomly sampled group of keywords. Blocks 1005-1015 are repeated until M test groups have been created, and processing returns to the calling routine in block 1099.

FIG. 11 illustrates an embodiment of subroutine 1100 (the Iterative Refinement Process) implemented as a genetic algorithm. In block 1120, a fitness function is derived from the metric criteria received in block 710 and the performance metrics received in block 740 (both received by the main routine). This fitness function is not restricted to a single performance metric from iteration to iteration. In some embodiments, the fitness function may initially be based on an impressions metric, but may switch to a clicks metric after a certain threshold of impressions is exceeded. For example, at least 200 clicks per day for an iteration of 20 ad groups may be required before the term evaluated by the fitness function may be changed from impressions to clicks. In additional embodiments, conversion metrics may be incorporated into the fitness function at some stage if sufficient conversion traffic is observed.

In block 1125, the best performing of the set of M original test ad groups is determined. In block 1130, M/2 breeding pairs of ad groups are selected from among the set of M original test ad groups. In one embodiment, individual test ad groups have a probability of being selected that is directly proportionate to their fitness (roulette wheel selection), but other known selection methods may also be employed. In block 1135, a new set of M offspring test ad groups is obtained from the M/2 selected breeding pairs. In some embodiments, single point crossover with a fixed rate (such as 0.7) is used to obtain the M offspring test ad groups, but other crossover rates and even other crossover methods may be utilized in other embodiments. In block 1140, the M offspring test ad groups are mutated, using a fixed mutation rate in one embodiment (a mutation rate of 0.01 is common). In the mutation process each keyword is randomly added or deleted from the ad group with the known mutation rate for each keyword. In block 1145, one of the offspring test ad groups is randomly replaced by the best performing original test ad group that was determined in block 1125, a process known in the art as “elitism.” In block 1150, any duplicates among the offspring test ad groups are replaced with replacement ad groups, each having a randomly generated list of keywords. In one embodiment, each keyword has a 50% chance of being included in a replacement ad group. A new set of M test ad groups having been created, processing returns to the calling routine in block 1199.

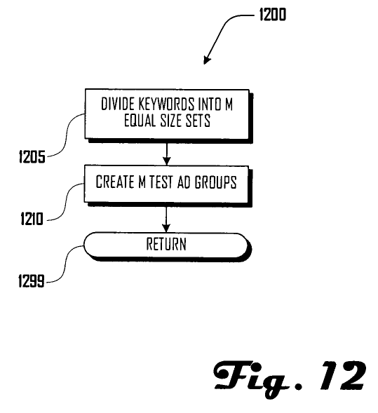

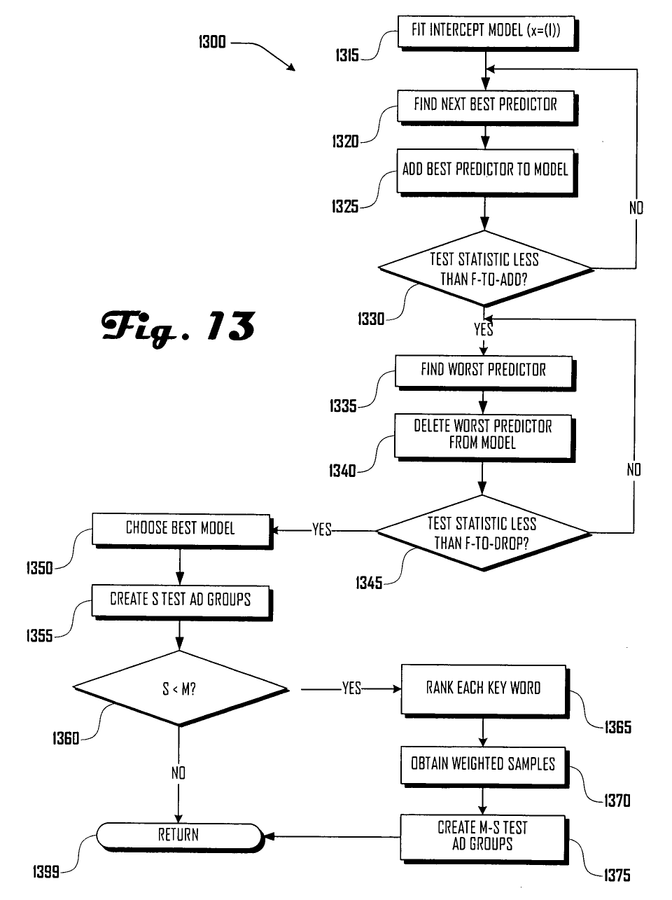

In alternate embodiments, illustrated in FIGS. 12 and 13, adaptive logistic models can be used to optimize with respect to a test ad group the probability of an impression, clickthrough, or conversion. Adaptive logistic models may be able to estimate clickthrough or conversion probabilities and create test ad groups in much the same manner as embodiments that use neural networks for this task. Adaptive logistic models are well known in the art, and the underlying concepts and statistics need not be described in detail to enable one skilled in the art to practice the claimed inventions.

Such embodiments may define the adaptive logistic model as follows. Let yⱼ be 1 for a clickthrough (or conversion, or other metric of interest) in the j^{th} test ad group and 0 otherwise. Let x_{j,k} be 1 if the j^{th} test ad group contains the k^{th} keyword, and let it be zero otherwise. Let β denote a vector of to-be-estimated coefficients. In such a case, the logistic model gives the probability of a clickthrough (or conversion, or other metric of interest) as

$$P ( {y}_{j} = 1 ) = \frac{exp ( {\sum }_{k} {γ}_{k} ( {x}_{j} ) {β}_{k} )}{1 + exp ( {\sum }_{k} {γ}_{k} ( {x}_{j} ) {β}_{k} )}$$

where γₖ (xⱼ) is 1 if the combination of keywords defined by γₖ is present in the j^{th} ad group, otherwise γₖ(xⱼ) is 0.

In general β must be estimated from the collected metric performance data. Maximum likelihood estimation may be used, in which the logistic model coefficients β are found such that they maximize the log-likelihood criterion. This criterion is given as

$$𝓁 ( β ) = {\sum }_{j} {y}_{j} {\sum }_{k} {γ}_{k} ( {x}_{j} ) {β}_{k} - ln ( 1 + exp ( {\sum }_{k} {γ}_{k} ( {x}_{j} ) {β}_{k} ) ) .$$

The maximum likelihood estimate is denoted by placing a “hat” over β, i.e., \hat{β}, and is given as \hat{β}=arg max l(β). (This equation states merely that \hat{β} maximizes the likelihood function l(β).) The Bernoulli (0, 1) deviates (TRUE or FALSE values, or, e.g., clickthrough, no clickthrough) in each ad group may be summed or aggregated.

In many embodiments, the functions γₖ(xᵢ) must be estimated from the collected metric performance data in an adaptive manner. Selection proceeds much like a stepwise regression analysis except that large sample statistics are used.

FIG. 12 illustrates an adaptive logistic embodiment of subroutine 1200. In block 1205, the total set of keywords is divided into nearly equal sized sets of keywords such that each keyword appears in a fixed number of sets (no keyword is allowed to be eliminated altogether). In block 1210, M test ad groups are created using the nearly equal sized sets. Processing returns to the main process in block 1299.

FIG. 13 illustrates an embodiment of subroutine 1300 (the Iterative Refinement Process) using an adaptive logistic model. In block 1315, the intercept model is fitted. In typical embodiments, x=(1). Modeling a particular ad at a section yields a constant probability, so the intercept model corresponds to the “current” model.

In blocks 1320-30, “best” predictors are added into the model in a series of steps. In block 1320, the best predictor at each step is found using an asymptotic (large n) statistical test. In an exemplary embodiment, the asymptotic statistical test is the Rao test. In block 1325, the “best” predictor for the step is added into the model and the logistic model estimates are recomputed. Decision block 1330 determines whether the asymptotic test statistic for the current step is less than a user specified F-to-Add value (if the increase in Rao statistic is less than the specified F-to-Add value, no predictor is likely to add to the model's predictive ability). If so, then processing continues to block 1335 and no more terms are added to the model. If not, processing returns to block 1320 and the best predictor for the next step is found. In one embodiment, predictors, γₖ(xᵢ), are chosen from the following set:
γₖ(xⱼ)=x_{j,k}
γₖ(xⱼ)=x_{j,k}×γᵢ(xⱼ) where l<k, a cross-product term. Using these cross-products, indicator variables γₖ(xⱼ) are deployed (the indicator variables are zero unless all ad words in a large set of ad words is present).

In blocks 1335-45, the worst predictor is deleted from the model in a series of steps. In block 1345, the worst predictor is found using an asymptotic statistical test statistic. In an exemplary embodiment, asymptotic statistical test statistic is the Wald statistic. In block 1340, the worst predictor is deleted from the model. Decision block 1345 determines whether the asymptotic test statistic for the current step is greater than a user specified F-to-Drop value (if the asymptotic test statistics for all remaining model predictors are larger than the F-to-Drop value, all predictors are likely to be important). If so, then processing continues to block 1350 and no more terms are deleted from the model. If not, processing returns to block 1335 and the worst predictor for the next step is found.

In block 1350, in one embodiment, the “best” model is chosen to minimize the Akaike Information Criterion (“AIC”) statistic. The AIC statistic is computed as −2 l(\hat{β})+λp where λ is a user specified penalty and where p is the number of elements in β. In many embodiments, λ may be non-negative and should increase with the number of impressions. Setting λ=0 may result in the largest possible model, a model that may often over fit the data. In a preferred embodiment, λ is set to a value greater than 2 and should increase with the length problem size (the length of y). Using λ=ln(nᵢₘₚ) may result in the Bayesian Information Criterion (“BIC”) statistic. In many embodiments, values of λ much larger than 2 may be used (e.g., the BIC criterion) to prevent overfitting the model to the data. In such embodiments, models with fewer terms are favored over models with more terms if both models lead to the same AIC statistic.

The chosen best model yields a series of provisional keyword groups defined by the selected terms. In block 1355, a set of S test ad groups is created based on those provisional keyword groups that have a high probability. Decision block 1360 determines whether enough test ad groups have been created. If M test ad groups have been created, block 1399 returns to the calling process. If additional ad groups are needed, in blocks 1365-75, the subroutine finds the remaining M-S keyword groups needed to create the remaining M-S test ad groups. In block 1365, each keyword is ranked according to its contribution (by itself) to the fitness function. In block 1370 roughly equally sized samples are obtained from the keywords wherein the sampling is weighted such that the keyword contributing the most has the highest probability of selection. In block 1375, M-S test ad groups are created in accordance with the roughly equally sized samples obtained in block 1370. In block 1399, processing returns to the calling process

In a fourth alternative embodiment, a simulated annealing algorithm is used in the iterative refinement phase. Simulated annealing algorithms are well known in the art, and the underlying concepts and statistics need not be described in detail to enable one skilled in the art to practice the claimed inventions. As in the genetic algorithm, each ad group is represented as a bit string of zeros and ones, where a one indicates the presence of the keyword in the ad group, and a zero indicates the absence of the keyword. Unlike the genetic algorithm, on each iteration the fitness function for each keyword group, called the control group, is compared with a randomly varied version of itself, called the test group, where the random variation is obtained by randomly switching the bits defining the ad group. Generally the probability of switching a bit is small (e.g., 0.01) and different probability schemes may be used for the bit switching. For example, all the probability of switching a bit (adding or removing a keyword) may be the same for all bits, or it can be function of a function associated with the keyword. For example, keywords associated with ad groups with high click through rates may have smaller bit switching probabilities that keywords associated with ad groups with small click through rates.

On the first iteration, for each test and control ad group the ad group yielding the lowest “cost” is selected and carried over to iteration 2 as the control group. (The term “cost” refers to a performance metric that has been selected to be minimized in a simulated annealing embodiment. For example, the cost might be defined as the negative of the clickthrough rate if the aim is to obtain the keywords list with highest possible clickthrough rate.) On iteration 2, and subsequent iterations, a new test group is obtained from each control group in the same manner described above. For each test group/control group pair, the control group and test group costs are compared. If the test group cost is less than the control group cost, the test group is used as the control group in the next iteration. Otherwise, the test group is used as the control group in the next iteration with a probability that is obtained from the difference in costs of the test and control groups in the current iteration and that decreases to zero as the number of iterations increases, in the usual manner for simulated annealing. If the test group is not used in the next iteration, the control group in the current iteration becomes the control group in the next iteration. In one embodiment, a simulated annealing algorithm may be implemented with periodic restarting since the Internet usage patterns change over time.

Although four exemplary embodiments of the Iterative Refinement Process have been described, a CAPO may be implemented using other types of Iterative Refinement Process.

Regardless of how the Iterative Refinement Process is implemented, while the CAPO is running, an advertiser may wish to add or remove keywords from the set of T keywords. The advertiser may add new keywords at any time, and new keywords are randomly incorporated into the test groups, distinct from the Iterative Refinement Process. Similarly, the advertiser may delete keywords at any time, and deleted keywords are removed from the test groups, distinct from the Iterative Refinement Process.

In an alternate embodiment, an advertiser may wish to continuously optimize ad groups for the duration of its ad campaign. In this case, the target criteria may be set so that the CAPO proceeds from decision block 755 to decision block 720 until the advertiser decides to terminate the campaign. In another embodiment, an advertiser may periodically run a CAPO to compensate for any changes an ad network provider may have made to its ad selection algorithm.

In yet another embodiment, an advertiser may run a series of CAPOs, optimizing for different criteria in each. For example, an advertiser may run a CAPO to optimize its ad campaign to maximize the number of impressions generated. Once an impressions target has been reached, the advertiser may run a second CAPO using a number of clicks or a clickthrough rate as target criteria. An advertiser may run yet another CAPO to optimize for conversions.

In a related embodiment, an advertiser may be able to update the metric criteria (including metrics of interest and targets) during the execution of the CAPO. For example, an advertiser may begin the CAPO using a number of impressions, an impression rate, and/or a cost per impression as metrics of interest and a target. But after a period of time (or after a number of iterations, or after the target is reached), the advertiser may alter the metric criteria to focus on, for example, a number of clicks, a clickthrough rate, and/or a cost per click. Later, the advertiser may alter the metric criteria yet again to focus on, for example, a number of conversions, a conversions rate, and/or a cost per conversion. Furthermore, during execution, the Advertiser may also change other aspects of the campaign, such as master keyword list composition, bid levels, or ad content.

Due to the characteristics of the content ad selection algorithm 230 used by an ad network provider, the results of an ad group keyword set for content targeted advertising may be unpredictable. Unlike search advertising, wherein individual keywords within an ad group may be treated independently, many content ad selection algorithms 230 may treat individual keywords within an ad group collectively. Therefore, adding a keyword to an ad group may result in unpredictable performance, including diminished effectiveness. In addition, deleting one or more keywords from an ad group may unpredictably result in improved performance of the ad group, depending on the particular content ad selection algorithm 230 used by the ad network provider. The actual details of a content ad selection algorithm 230 may be unknown to and undiscoverable by an advertiser. Providers like Google and Yahoo often purposefully keep their content ad selection algorithms secret to prevent advertisers from exploiting the content ad selection algorithms 230.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the embodiments discussed herein.

What is claimed is:

1. A computer-implemented method of generating optimized content ad groups, the method comprising:
obtaining a first keyword list for a target ad campaign;
obtaining target performance metric criteria for the target ad campaign;
creating a control ad group comprising the first keyword list; and
performing an iterative keyword optimization routine, wherein each iteration includes:
creating a plurality of test ad groups, each of said test ad groups comprising a test subset of keywords selected from said first keyword list, wherein:
on a first iteration, each test subset of keywords is selected by a random process; and
on subsequent iterations, each test subset of keywords is generated by an iterative refinement process in accordance with a plurality of better-performing complementary ad groups selected in the preceding iteration;
running each of said test ad groups for a period of time;
in accordance with said target performance metric criteria, tracking a test performance metric for each of said test ad groups;
in accordance with said test performance metrics, selecting a new plurality of better-performing complementary ad groups from among test ad groups.

2. The method of claim 1, further comprising ending the optimization routine when the test performance metrics of the plurality of better-performing complementary ad groups meet said target performance metric criteria.

3. The method of claim 2, further comprising running the plurality of better-performing complementary ad groups in the target ad campaign.

4. The method of claim 1, further comprising continuously optimizing said target ad campaign.

5. The method of claim 1, wherein said test performance metric is obtained from at least one of a content targeted advertising service provider and an advertiser.

6. The method of claim 1, wherein the method operates without knowledge of the ad network's content ad selection algorithm.

7. The method of claim 1, wherein said iterative refinement process includes at least one of artificial neural network, genetic algorithm, adaptive logistics algorithm, and simulated annealing.

8. The method of claim 1, wherein said iterative refinement process comprises:
selecting a plurality of parent pairs from said test ad groups in accordance with said target performance metric criteria;
creating a pair of offspring from each of said plurality of parent pairs; and
mutating said pair of offspring in accordance with a mutation probability.

9. The method of claim 8, wherein the probability that each of said test ad groups will be selected as a parent pair is directly proportional to its fitness in accordance with said target performance metric criteria.

10. The method of claim 8, wherein creating a pair of offspring from each of said plurality of parent pairs comprises:
selecting a first group of keywords from a first ad group of the parent pair;
selecting a second group of keywords from a second ad group of the parent pair; and
in accordance with a crossover probability, swapping said first and second groups of keywords.

11. The method of claim 10, wherein said crossover probability is approximately 0.7.

12. The method of claim 8, wherein said mutation probability is approximately 0.01.

13. The method of claim 8, wherein said iterative refinement process further comprises:
determining a most fit test ad group from a previous iteration; and
selecting said most fit test group for said new plurality of better-performing complementary ad groups.

14. The method of claim 8, wherein said iterative refinement process further comprises replacing a duplicate ad group within said test ad groups with a replacement ad group comprising a randomly selected list of keywords from said first keyword list.

15. The method of claim 1, wherein said iterative keyword optimization routine further comprises obtaining new target performance metric criteria.

16. The method of claim 1, wherein said iterative keyword optimization routine further comprises obtaining new target performance metric criteria if said test performance metric exceeds a threshold.

17. The method of claim 1, further comprising incorporating a new keyword into at least one of said first keyword list and said test ad groups.

18. The method of claim 1, further comprising:
obtaining a new keyword;
adding said new keyword to said first keyword list; and
randomly incorporating said new keyword into at least one of said test ad groups.

19. The method of claim 1, further comprising:
removing a keyword from said first keyword list; and
deleting said removed keyword from at least one of said test ad groups.

20. The method of claim 1, wherein said target performance metric criteria comprise at least one of a number of impressions, a number of clicks, a number of conversions, an impression rate, a clickthrough rate, a conversion rate, a cost per impression, a cost per click, and a cost per conversion.

21. The method of claim 1, wherein said target ad campaign is run in accordance with at least one of a product launch, a marketing campaign, a holiday, and a range of dates.

22. The method of claim 1, wherein said iterative keyword optimization routine further comprises at least one of changing a bid for a keyword, changing a landing page of said target ad campaign, and changing a content of an ad of said target ad campaign.

23. The method of claim 1, wherein said first keyword list and said target performance metric criteria are obtained via a network.

24. A computing apparatus comprising a processor and a memory having executable instructions for performing the method of claim 1.

25. A computer readable medium comprising executable instructions for performing the method of claim 1.
